(19) United States
(12) Patent Application Publication
(10) Pub. No.: US 2026/0031724 A1
(43) Pub. Date: Jan. 29, 2026

(54) POWER SOURCE ASSEMBLY FOR AERONAUTICAL VEHICLE

(71) Applicants: General Electric Deutschland Holding GmbH, Frankfurt (DE); GE Marmara Technology Center Muhendislik Hizmetleri Ltd, Tekseb (TR)

(72) Inventors: Cosimo Spagnolo, Unterschleisheim (DE); Ekrem Cengelci, Darica (TR); Mohamed Osama, Garching (DE)

(21) Appl. No.: 18/782,184

(22) Filed: Jul. 24, 2024

(51) Int. Cl. H02M 3/155; B64D 27/355; H01M 8/04858; H01M 10/42; H01M 16/00

(52) U.S. Cl. CPC H02M 3/155; B64D 27/355; H01M 8/04925; H01M 10/425; H01M 16/006; H01M 2220/20; H01M 2250/20; H01M 2250/402

(57) ABSTRACT

A power source assembly for an aeronautical vehicle includes a fuel cell module configured to provide a first direct current (DC) power output, a battery module configured to provide a second DC power output, a DC electric bus configured to provide a specified DC power output to a load, a multi-phase DC/DC converter including a plurality of converter units, and a controller operably coupled to the multi-phase DC/DC converter. The multi-phase DC/DC converter is configured to receive the first DC power output and the second DC power output and to provide the specified DC power output to the DC electric bus. The controller is configured to receive data indicative of the first DC power output and to control the plurality of converter units of the multi-phase DC/DC converter based on the received data to maintain the specified DC power output to the load.

### FIELD

The present disclosure relates to a power source assembly for an aeronautical vehicle.

### BACKGROUND

Aeronautical vehicles use a variety of power sources to drive one or more propulsors that may generate thrust for the vehicles. Many vehicles use gas turbine engines, having a turbomachine and a rotor assembly. While gas turbine engines have advanced significantly over the years, it may be beneficial to examine inclusion of other power sources as a primary or secondary source of power for the vehicle. However, in the process of developing new power sources, it may be important to make sure that the new technologies do not create other inefficiencies in the form of excess weight, or the like.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is schematic, perspective view of an aeronautical vehicle in accordance with an aspect of the present disclosure.

FIG. 2 is a schematic, perspective view of a gas turbine engine in accordance with an aspect of the present disclosure.

FIG. 3 is a schematic, perspective view of an electric propulsor in accordance with an aspect of the present disclosure.

FIG. 4 is a schematic view of a fuel cell module in accordance with an exemplary aspect of the present disclosure.

FIG. 5 is a schematic diagram of a power source assembly for an aeronautical vehicle in accordance with an exemplary aspect of the present disclosure.

FIG. 6 is a chart depicting power output of a power source assembly in accordance with an exemplary aspect of the present disclosure.

FIG. 7 is a schematic diagram of a power source assembly for an aeronautical vehicle in accordance with another exemplary aspect of the present disclosure.

FIG. 8 is a schematic diagram of a power source assembly for an aeronautical vehicle in accordance with yet another exemplary aspect of the present disclosure.

FIG. 9 is schematic view of a controller in accordance with an exemplary aspect of the present disclosure.

FIG. 10 is a flow diagram of a method for controlling a power source assembly of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

The term “at least one of” in the context of, e.g., “at least one of A, B, and C” refers to only A, only B, only C, or any combination of A, B, and C.

As used herein, the terms “first,” “second,” “third,” “fourth,” and other ordinals are used to distinguish one component from another and are not intended to signify location or importance of the individual components.

As used herein, the term “maximum power draw” refers to the maximum amount of electric power required for a particular component during all anticipated non-failure mode and non-emergency mode operations for the particular component.

The present disclosure is generally related to a power source assembly for an aeronautical vehicle. The power source assembly may be configured to drive a load, such as an electric propulsor of the aeronautical vehicle. The power source assembly may generally include a fuel cell module configured to provide a first direct current (DC) power output, a battery module configured to provide a second DC power output, a multi-phase DC/DC converter configured to receive the first DC power output from the fuel cell module and the second DC power output from the battery module, and a controller. The controller may be operatively coupled to the multi-phase DC/DC converter and configured to receive data indicative of the first DC power output.

In such a manner, it will be appreciated that the multi-phase DC/DC converter may ensure that the power output of the fuel cell module is not varied too quickly in response to a change in a power output demand on the power source assembly. For example, it will be appreciated that rapid changes in the amount of power drawn from a fuel cell module during flight operations can have negative effects on the life and reliability of a fuel cell module. For example, if a Proton Exchange Membrane Fuel Cell (PEMFC) is subjected to rapid load changes, certain catalysts may be dissolved, and/or a low reactant condition may happen. A battery module may be provided having a power rating comparable to that of the fuel cell module to support the fuel cell module during sudden load demands. The power output assembly topologies and control methodologies of the present disclosure allow for much a battery module having a much smaller energy capacity without compromising a life of the fuel cell module.

For example, in response to a request to increase a net power output of the power source assembly, the controller may initiate a ramp-up of the first direct current power output of the fuel cell module at a specified rate. In order to ensure the net power output of the power source assembly is sufficient to meet the power output demand on the power source assembly, the battery module may substantially instantaneously (e.g., within 10 seconds of detecting the power output demand) provide the difference between the current first direct current power output and the power output demand. The multi-phase DC/DC converter includes a plurality of converter units that are interleaved to selectively draw power from either the fuel cell module or the battery module. As the first direct current power output of the fuel cell module ramps up and reaches the power output demand, the second direct current power output of the battery module correspondingly decreases. Such a configuration may allow for a single interleaved DC/DC converter usable for both the fuel cell module and the battery module, rather than two dedicated DC/DC converters, allowing for an overall lighter system while still providing a tightly regulated DC bus voltage for the load.

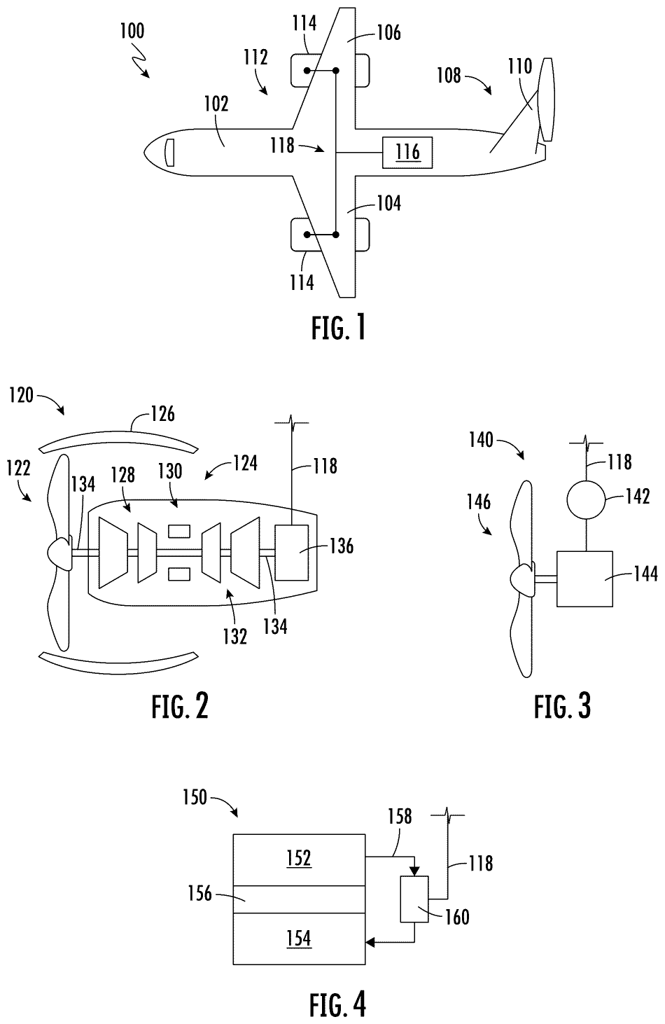

Referring now to the drawings, wherein identical numerals indicate the same elements throughout the figures, FIG. 1 is a schematic view of an aeronautical vehicle 100 in accordance with an exemplary embodiment of the present disclosure. The exemplary aeronautical vehicle 100 of FIG. 1 is configured as an aircraft. The aircraft generally includes a fuselage 102 forming a main body portion of the vehicle 100, a first wing 104 extending from a port side of the aircraft and a second wing 106 extending from a starboard side of the aircraft. The first and second wings 104, 106 each extend laterally from the fuselage 102. The aircraft further includes an empennage 108 having one or more stabilizer 110, and, in particular, including a vertical stabilizer and a horizontal stabilizer.

The vehicle 100 further includes a propulsion system 112 that includes one or more propulsors 114 and one or more power sources 116. The propulsion system 112 further includes an electric power distribution bus 118 electrical coupling various components of the propulsion system 112.

Referring now to FIG. 2, a schematic view of a propulsor as may be incorporated into the exemplary propulsion system 112 of the vehicle 100 of FIG. 1 is provided. More specifically, for the embodiment depicted, the propulsor is configured as a gas turbine engine 120, and more specifically, still, the gas turbine engine 120 of FIG. 2 is configured as a turbofan engine. The turbofan engine includes a fan section 122 and a turbomachine 124 drivingly coupled to the fan section 122. The turbofan engine further includes an outer nacelle 126 enclosing at least in part the fan section 122 and the turbomachine 124. The turbomachine 124 generally includes a compressor section 128, a combustion section 130, and a turbine section 132 arranged in serial flow order, and one or more shafts 134 connecting, e.g., a fan of the fan section 122, one or more compressors of the compressor section 128, and one or more turbines of the turbine section 132. Moreover, for the embodiment of FIG. 2, the turbofan engine further includes an electric machine 136 rotatable with the one or more shafts 134 of the turbomachine 124, with the fan section 122, or both. The electric machine 136 may be configured to extract electrical power from the turbofan engine and provide such electrical power to an electric power distribution bus 118, such as the electric power distribution bus 118 of FIG. 1. Additionally, or alternatively, the electric machine 136 may be configured to receive electric power from the electric power distribution bus 118 to, e.g., drive the fan of the fan section 122.

Referring now to FIG. 3, a schematic view of a propulsor as may be incorporated into the exemplary propulsion system 112 of the vehicle 100 of FIG. 1 in accordance with another exemplary aspect of the present disclosure is provided. For the embodiment of FIG. 3, the propulsor is configured as an electric fan 140. The electric fan 140 generally includes an inverter 142, an electric machine 144 (e.g., in the form of an electric motor), and a fan 146.

The inverter 142 is configured to receive electrical power from, e.g., an electric power distribution bus 118 (such as the electric power distribution bus 118 of FIG. 1) and convert the received electrical power from, e.g., a direct-current (“DC”) electrical power to an alternating current (“AC”) electrical power. The electric machine 144 is configured as an electric motor configured to receive the electric power from the inverter 142 and convert the electric power into a mechanical, rotational force to drive the fan 146 and generate thrust.

Referring now to FIG. 4, a power source is provided, which may be incorporated into the exemplary propulsion system 112 of the vehicle 100 of FIG. 1 in accordance with an exemplary aspect of the present disclosure. The power source is more specifically a fuel cell 150. Fuel cells are electro-chemical devices which can convert chemical energy from a fuel into electrical energy through an electro-chemical reaction of the fuel, such as hydrogen, with an oxidizer, such as oxygen contained in the atmospheric air.

The fuel cell 150 of FIG. 4 includes an anode 152, a cathode 154, and an electrolyte layer 156 positioned between the anode 152 and the cathode 154. During operation, fuel, such as a hydrogen fuel, is provided to the anode 152 and an oxygen containing gas, such as air, is provided to the cathode 154. Within the anode 152, hydrogen molecules from the fuel may be separated into protons and electrons, with the electrolyte layer 156 allowing only protons to pass through to the cathode 154. The electrons travel through an external electrical circuit 158 which may be electrically coupled to an electric power distribution bus 118, such as the electric power distribution bus 118 of FIG. 1, through a juncture box 160 (including e.g., various power electronics). At the cathode 154, protons, electrons, and oxygen are combined to form water as a byproduct.

As will be appreciated, the vehicle 100 depicted in FIG. 1 is provided by way of example only, and, in other exemplary embodiments, aspects of the present disclosure may be incorporated into any other suitable aeronautical vehicle 100. Similarly, the propulsors depicted in FIGS. 1 through 3 are also provided by way of example only. In other exemplary embodiments, aspects of the present disclosure may be incorporated into, or otherwise utilized with, any other suitable propulsors, such as any other suitable gas turbine engines having an electric machine (e.g., other turbofan engines, open rotor turbofan engines, turboprop engines, turboshaft engines, turbojet engines), any other suitable electric fans (e.g., ducted fans, distributed fan, vertical thrust fans, horizontal thrust fans, combination fans), or the like.

Further, it will be appreciated that the fuel cell 150 depicted as the power source in FIG. 4 may be any suitable type of fuel cell. Further, although a single fuel cell is depicted in FIG. 4, it will be appreciated that, as used herein, the term “fuel cell” may refer to a single fuel cell or an array of fuel cells connected to one another for providing an electrical power output. In particular, as a single fuel cell may only be able to generate on the order of 1 volt voltage, a plurality of fuel cells may be stacked together (which may be referred to as a fuel cell stack). One or more fuel cell stacks may form a fuel cell module, and one or more fuel cell modules may form a fuel cell system to generate a desired voltage. Further, the fuel cell may be of any suitable chemistry. For example, the fuel cell 150 may include Solid Oxide Fuel Cells (SOFC), Molten Carbonate Fuel Cells (MCFC), Phosphoric Acid Fuel Cells (PAFC), and Proton Exchange Membrane Fuel Cells (PEMFC), all generally named after their respective electrolyte layers. Each of these fuel cells may have specific benefits in the form of a preferred operating temperature range, power generation capability, efficiency, etc.

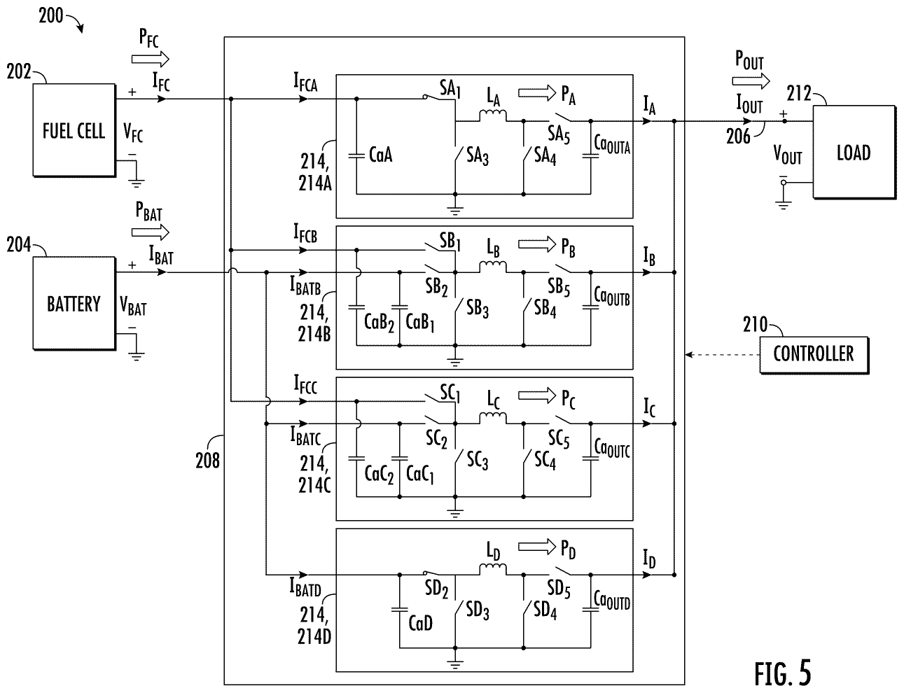

Referring now to FIG. 5, a schematic view of a power source assembly for the aeronautical vehicle 100 is shown. The exemplary power source assembly 200 of FIG. 5 may be integrated into one or more of the exemplary aeronautical vehicles described herein (see, e.g., vehicle 100 of FIG. 1), may be used with one or more of the propulsors described herein (see, e.g., FIGS. 2 and 3), and may utilize one or more of the exemplary power sources described herein (see, e.g., FIG. 4).

More specifically, FIG. 5 schematically depicts an electric circuit for the power source assembly 200. The power source assembly 200 includes a fuel cell module 202, a battery module 204, a DC electric bus 206, a multi-phase DC/DC converter 208, and a controller 210. The power source assembly 200 manages power output from the fuel cell module and 202 the battery module 204 with the multi-phase DC/DC converter 208 to provide a specified power output from the DC electric bus 206 to a load 212, such as a propulsor as described above.

The fuel cell module 202 may include one or more fuel cell stacks (which, in turn, may include a plurality fuel cells, such as a plurality of the fuel cells 150 of FIG. 4) and is configured to provide a fuel cell module DC power output P_{FC} during, e.g., an operating condition of the power source assembly 200. In particular, the fuel cell module 202 is configured to provide a fuel cell voltage output V_{FC} and a fuel cell module current output I_{FC} during the operating condition of the power source assembly. The fuel cell module 202 may be configured to generate a maximum power output of at least 100 kilowatts (kW) and up to 2,000 kW, such as between 200 kW and 1,200 kW.

The battery module 204 is configured to provide a battery DC power output P_{BAT} during, e.g., the operating condition of the power source assembly 200. In particular, the battery module 204 is configured to provide a battery voltage output V_{BAT} and a battery current output IBAT during the operating condition of the power source assembly. The battery module 204 may be configured in any suitable manner to store electrical power. In certain exemplary embodiments, the battery module 204 may include one or more lithium-ion batteries, and/or one or more batteries of other suitable chemistry.

The battery module 204 may be configured to store at least 5 kilowatt-hours (kWh) and up to 100 kWh. In such a manner, as will be appreciated from the description herein, a storage capacity of the battery module 204 may be relatively low compared to a maximum power output of the fuel cell module 202. For example, a ratio of the storage capacity of the battery module 204 to a maximum power output of the fuel cell module 202 may be less than 30 kWh to 850 KW (which is an equivalent of less than 2 minutes and seven seconds of maximum power output).

The multi-phase DC/DC converter 208 is configured to regulate output from the fuel cell module 202 and the battery module 204 to provide a specific power output to the DC electric bus 206. More specifically, the multi-phase DC/DC converter 208 includes a plurality of converter units 214 or “phases” that each electrically connect the fuel cell module 202, the battery module 204, or both to the DC electric bus 206. The multi-phase DC/DC converter 208 configured to receive the fuel cell module DC power output P_{FC} from the fuel cell module 202 and the battery DC power output P_{BAT} from the battery module 204 and to provide the specified DC power output P_{OUT} to the DC electric bus 206, which is configured to provide the specified DC power output P_{OUT} to the load 212. The exemplary multi-phase DC/DC converter 208 of FIG. 5 has four converter units 214, including a first converter unit 214A, a second converter unit 214B, a third converter unit 214C, and a fourth converter unit 214D (collectively, “converter units 214”). It will be appreciated that the multi-phase DC/DC converter 208 may include a different number of converter units 214, such as three, five, or six.

Each of the plurality of converter units 214 is electrically connected to at least one of the fuel cell module 202 or the battery module 204 to provide at least a portion of the fuel cell module DC power output P_{FC} or the battery DC power output P_{BAT} to the DC electric bus 206. Specifically, each of the plurality of converter units 214 includes at least one switch S operable from an open state to a closed state. When the switch S is in the closed state, current (generally shown with the reference “I”) is provided from the fuel cell module 202 or the battery module 204 through the converter unit 214 to the DC electric bus 206. When the switch S is in the open state, no current passes through. At least one converter unit 214 includes a second switch S operable from an open state to a closed state that connects the other of the fuel cell module 202 or the battery module 204 to the converter unit 214. That is, some of the converter units are electrically connected to both of the fuel cell module 202 and the battery module 204, and some of the converter units 214 are connected to only one of the fuel cell module 202 or the battery module 204. The switches S may be one or more of several forms, such as toggles, rotaries, push-buttons, rockers, membranes, metal-oxide semiconductor field-effect transistors (MOSFET) such as silicon carbide MOSFETs, insulated-gate bipolar transistors (IGBT), or combinations thereof.

In FIG. 5, each switch S is labeled according to the converter unit 214 in which the switch S is installed and whether the switch S is connected to the fuel cell module 202 or the battery module 204. In the example of FIG. 5, the first converter unit 214A includes a switch SAI that is electrically connected to the fuel cell module 202, the second converter unit 214B includes a first switch SB1 connected to the fuel cell module 202 and a second switch SB2 connected to the battery module 204, the third converter unit 214C includes a first switch SC1 connected to the fuel cell module 202 and a second switch SC2 connected to the battery module 204, and the fourth converter unit 214D includes a switch SD2 that is electrically connected to the battery module 204. That is, the first converter unit has only a single switch SAI that is connected only to the fuel cell module 202, and the fourth converter unit has only a single switch SD2 is connected only to the battery module 204, and only three of the four converter units 214 shown in FIG. 5 are connected to each of the fuel cell module 202 and the battery module 204. Because the converter units 214 are interconnected to both the fuel cell module 202 and the battery module 204, the multi-phase DC/DC converter 208 may be referred to as an “interleaved multiphase modular DC/DC converter.”

Each of the converter units 214 includes additional electrical circuit components to control electric current. Such electrical circuit components include capacitors C, inductors L, and other switches S. Each of the other components is marked according to the specific converter unit in which the component is installed. As an example, the switch SA3 is installed in the first converter unit 214A and is the third of four switches S. As another example, the second converter unit 214B includes an inductor LB and capacitors CB1 and CB2. In general, each converter unit 214 includes the electrical circuit components such that an amount of DC power output that each of the plurality of converter units 214 provides to the DC electric bus 206 is substantially equal, e.g., within 10% of the DC power output of each other converter unit 214.

The power source assembly 200 includes a controller 210 operably coupled to the multi-phase DC/DC converter 208. The controller 210 is configured to control the plurality of converter units 214 of the multi-phase DC/DC converter 208 based on the data indicative of the battery DC power output P_{BAT} and the fuel cell module DC power output P_{FC} to maintain the specified DC power output P_{OUT} to the load 212. More specifically, the controller 210 is configured to actuate the switches S of each of the plurality of converter units 214 to the open state or the closed state to provide current from the fuel cell module 202 and the battery module 204 to provide the specified DC power output.

As the fuel cell module DC power output P_{FC} increases, the controller 210 is configured to sequentially control each of the plurality of converter units 214 to increase a proportion of the specified DC power output from the fuel cell module DC power output P_{FC} and to decrease a proportion of the specified DC power output from the battery DC power output P_{BAT}. Specifically, the specified DC power output is a sum of the fuel cell module DC power output P_{FC} and the battery DC power output P_{BAT} output from the multi-phase DC/DC converter 208, and the controller 210 is configured to control the plurality of converter units 214 as the fuel cell module 202 ramps up or ramps down the fuel cell module DC power output P_{FC}. That is, the battery DC power output P_{BAT} is the difference between the specified DC power output P_{OUT} and the fuel cell module DC power output P_{FC}.

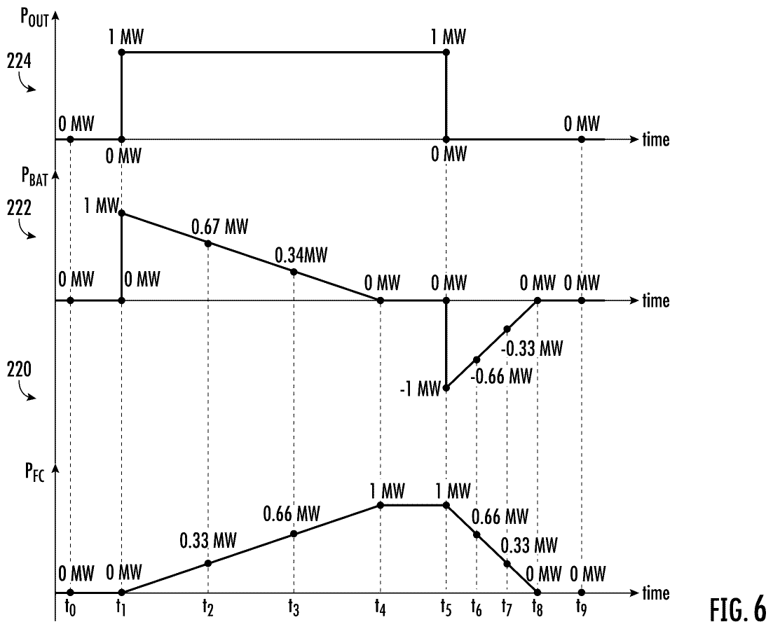

Now referring to FIG. 6, charts illustrating power output to the load 212 are shown. Specifically, FIG. 6 includes a first chart 220 showing the fuel cell module DC power output P_{FC} over a specified period of time, a second chart 222 showing the battery DC power output P_{BAT} over the specified period of time, and a third chart 224 showing the specified DC power output P_{OUT} over the specified period of time. The charts 220, 222, 224 are arranged such that the horizontal axis is the same for each chart and measures time in seconds elapsed from an initial time t₀ to a final time t₉, and the vertical axis for each chart 220, 222, 224 measures power in watts (W) and starts at 0. That is, for any specific time t, following the charts 220, 222, 224 vertically shows the fuel cell module DC power output P_{FC}, then the battery DC power output P_{BAT}, and finally the specified DC power output P_{OUT} at the time t. The power outputs are controlled by the multi-phase DC/DC converter 208 shown in FIG. 5, and reference to the converter units 214 when describing the example of FIG. 6 will refer to the four converter units 214 of FIG. 5. It will be appreciated that, when the multi-phase DC/DC converter 208 has a different number of converter units 214, the graphs shown in the charts 220, 222, 224 would have different slopes and different overall shapes.

The charts 220, 222, 224 illustrate how the power needs of the load 212 change over time and how the fuel cell module 202, the battery module 204, and the multi-phase DC/DC converter 208 operate to provide power to the load 212. Specifically, the charts 220, 222, 224 show how the specified DC power output P_{OUT} starts at 0 megawatts (MW) from t₀ to t₁, then increases to 1 MW from t₁ to t₅, and then decreases to 0 MW from t₅ to t₉. Because the fuel cell module 202 increases the fuel cell module DC power output P_{FC} over time, to provide the 1 MW output to the load 212, the battery module 204 provides battery DC power output P_{BAT} to supplement what the fuel cell module 202 does not provide. It will be appreciated that the sum of the fuel cell module DC power output P_{FC} and the battery module 204 provides the battery DC power output P_{BAT} at every time t in the charts equals the specified DC power output P_{OUT} in the chart.

The controller 210 is configured to actuate the multi-phase DC/DC converter 208 to provide power from the fuel cell module 202 and the battery module 204 to the load 212, actuating respective switches of the converter units 214 to selectively draw power as the fuel cell module 202 ramps up. Starting at to, the specified DC power output P_{OUT} is 0 MW, and the controller 210 actuates the switches S of the converter units 214 such that no power is provided to the DC electric bus 206.

Next, at a time t₁, the specified DC power output P_{OUT} is 1 MW, and the fuel cell module 202 begins to ramp up. The controller 210 actuates the switches SAI, SD2 of the first converter unit 214A and the fourth converter unit 214D to provide power from the fuel cell module 202 and the battery module 204, respectively. The controller 210 also actuates the second switch SB2 of the second converter unit 214B and the second switch SC2 of the third converter unit 214C to provide power from the battery module 204. Because the fuel cell module 202 cannot provide sufficient power to the DC electric bus 206, the second converter unit 214B, the third converter unit 214C, and the fourth converter unit 214D provide the entirety of the specified DC power output P_{OUT}. That is, each of the second converter unit 214B, the third converter unit 214C, and the fourth converter unit 214D are configured to provide up to 0.34 MW of power to the DC electric bus 206 (i.e., slightly more than one third of 1 MW), such that the battery DC power output P_{BAT} totals 1 MW and the fuel cell module DC power output P_{FC} is 0 MW.

Next, at a time t₂, the controller 210 actuates the first switch SB1 of the second converter unit 214B and deactivates the second switch SB2 of the second converter unit 214B to draw additional power from the fuel cell module 202. Because each converter unit 214 in the example of FIGS. 5-6 is configured to transfer no more than 0.34 MW to the DC electric bus 206, once the fuel cell module 202 produces more than 0.33 MW, the second converter unit 214B transfers the additional power from the fuel cell module 202 and ceases transferring power from the battery module 204.

Next, at a time t₃, the controller 210 actuates the first switch SC1 of the third converter unit 214C and deactivates the second switch SC2 of the third converter unit 214C. Because the power output from the fuel cell module 202 exceeds 0.66 MW, the third converter unit 214C transfers the additional power from the fuel cell module 202 and ceases transferring power from the battery module 204.

Next, at a time t₄, the first, second, and third converter units 214A, 214B, 214C provide 1 MW of power from the fuel cell module DC power output P_{FC} to the DC electric bus 206 to provide the specified DC power output P_{OUT}. The battery module 204 ceases providing power to the fourth converter unit 214D, and the fuel cell module 202 powers the entire load 212.

Next, at a time to, the load 212 no longer requires power and the specified DC power output P_{OUT} becomes 0 MW. That is, the load 212 becomes zero. Because the fuel cell module 202 requires time to ramp down the fuel cell module DC power output P_{FC}, the controller 210 actuates the converter units 214 to direct the fuel cell module DC power output P_{FC} to the battery module 204. The battery module 204 can receive the fuel cell module DC power output P_{FC} as a recharging power by generating a negative power output, i.e., the battery DC power output P_{BAT} starts at −1 MW and ramps down along with the fuel cell module 202.

To transfer the fuel cell module DC power output P_{FC} to the battery module 204, the controller 210 actuates the second switch SC2 of the third converter unit 214C and deactivates the switch SC1 of the third converter unit 214C, such that the first and second converter units 214A, 214B receive power from the fuel cell module 202, and the third and fourth converter units 214C, 214D transfer the power from the first and second converter units to the battery module 204. At the time t₅, each converter unit 214 is configured to provide 0.5 MW of power, greater than the 0.34 MW for powering the load 212, to ramp down the fuel cell module 202. As the fuel cell module 202 ramps down, the total amount of power provided by each converter unit decreases, reaching 0.33 MW at the time to.

Next, at a time t₇, the controller 210 actuates the second switch SB2 of the second converter unit 214B and deactivates the switch SB1 of the second converter unit 214B, and the remaining 0.33 MW of power from the fuel cell module 202 is transferred to the battery module 204. The second, third, and fourth converter units 214B, 214C, 214D are connected only to the battery module 204, and only the first converter unit 214A draws power from the fuel cell module 202. The fuel cell module 202 fully ramps down at a time to, and all of the fuel cell module DC power output P_{FC}, the battery DC power output P_{BAT}, and the specified DC power output P_{OUT} are at 0 MW until the chart ends at the time to. It will be appreciated that the numbers in the charts 220, 222, 224 of FIG. 6 are exemplary, and the specific power outputs from the fuel cell module 202 and the battery module 204 to the DC electric bus 206 will vary depending on the specific load 212.

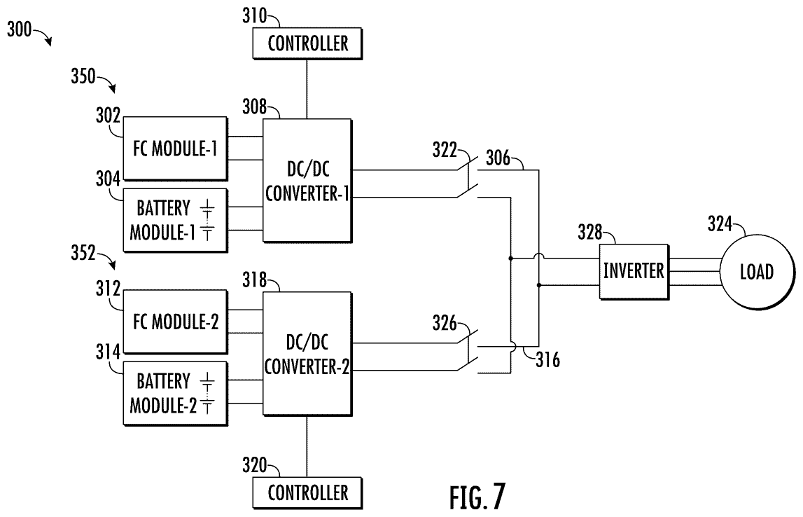

Referring now to FIG. 7, a power source assembly 300 in accordance with another exemplary aspect of the present disclosure is provided. The exemplary power source assembly 300 of FIG. 7 may be configured in a similar manner as one or more of the exemplary embodiments described above with reference to FIGS. 1 through 6.

More specifically, for the embodiment of FIG. 7, the power source assembly 300 is configured in a similar manner as the exemplary power source assembly described above with reference to FIG. 5. Accordingly, the exemplary power source assembly 300 generally includes a fuel cell module 302, a battery module 304, a DC electric bus 306, a multi-phase DC/DC converter 308, and a controller 310.

However, for the embodiment depicted, the fuel cell module 302, the battery module 304, the DC electric bus 306, the multi-phase DC/DC converter 308, and the controller 310, together form a first power assembly 350 and the power source assembly 300 further includes a second power assembly 352. The second power assembly 352 is configured in substantially the same manner as the first power assembly 350. Accordingly, it will be appreciated that the second power assembly 352 further includes a fuel cell module 312, a battery module 314, a DC electric bus 316, a multi-phase DC/DC converter 318, and a controller 320. The second power assembly 352 may be configured in substantially the same manner as the first power assembly 350 and may operate in substantially the same manner as the first power assembly 350. Accordingly, the components of the second power assembly 352 may also be configured in the same manner as the components of the power source assembly 200 described above with reference to FIG. 5.

However, for the embodiment of FIG. 7, the power source assembly 300 includes redundancy benefits. In particular, the second power assembly 352 provides redundancy to the first power assembly 350. Accordingly, it will be appreciated that the DC electric bus 306 of the first power assembly 350 includes a switch 322 to selectively electrically connect or disconnect the first power assembly 350 to a load 324, and similarly, the DC electric bus 316 of the second power assembly 352 includes a switch 326 to selectively electrically connect or disconnect the second power assembly 352 to the load 324. An inverter 328 provides alternating current from the first power assembly 350, the second power assembly 352, or both.

In such manner, the second power assembly 352 may be connected to the load 324 in the event of a failure of the first power assembly 350 to ensure the load 324 continues to receive electrical power during the failure condition.

Additionally or alternatively, each of the first power assembly 350 and the second power assembly 352 may be configured to provide less than 100% of an anticipated maximum power draw requested by the load 324, such that during a normal operating condition (e.g., a high power operating condition), both the first and second power assemblies 350, 352 provide electrical power to the load 324. With such a configuration, in the event of a failure of one of the first power assembly 350 or second power assembly 352, the other of the first power assembly 350 or the second power assembly 352 may ensure that the load 324 is capable of receiving at least some electric power during the failure condition.

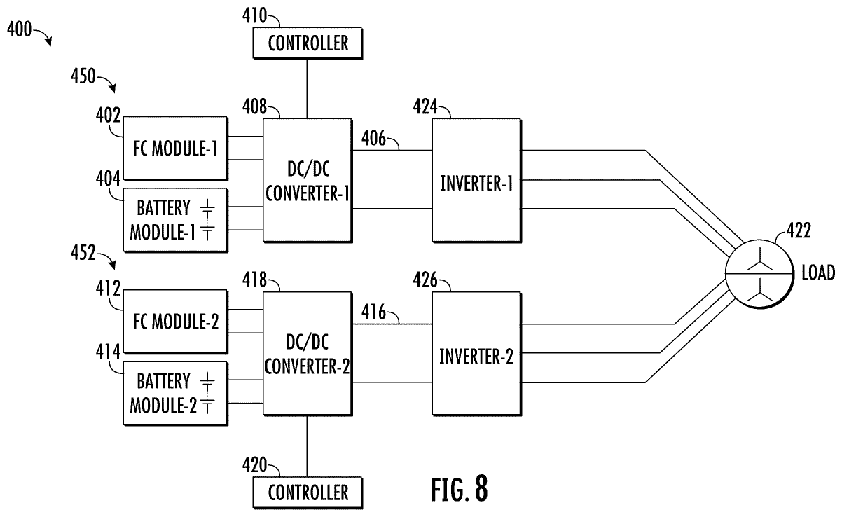

Further, referring now to FIG. 8, a power source assembly 400 in accordance with yet another exemplary embodiment of the present disclosure is provided. The exemplary power source assembly 400 of FIG. 8 is configured in substantially the same manner as exemplary power source assembly 300 of FIG. 7. Specifically, the power source assembly 400 includes a first power assembly 450 including a fuel cell module 402, a battery module 404, a DC electric bus 406, a multi-phase DC/DC converter 408, and a controller 410 and a second power assembly 452 including a fuel cell module 412, a battery module 414, a DC electric bus 416, a multi-phase DC/DC converter 418, and a controller 420. However, for the embodiment of FIG. 8, a load 422 includes a first inverter 424 electrically coupled to the DC electric bus 406 of the first power assembly 450 and a second inverter 426 electrically coupled to the DC electric bus 416 of the second power assembly 452. An electric motor of the load 422 may be configured to receive alternating current electric power from the first inverter 424, the second inverter 426, or both.

The power source assembly 400 of FIG. 8 may operate in substantially the same manner as the power source assembly 300 of FIG. 7 but may further provide redundancy in the load by inclusion of dedicated inverters 424, 426 for the first power assembly 450 and the second power assembly 452, respectively.

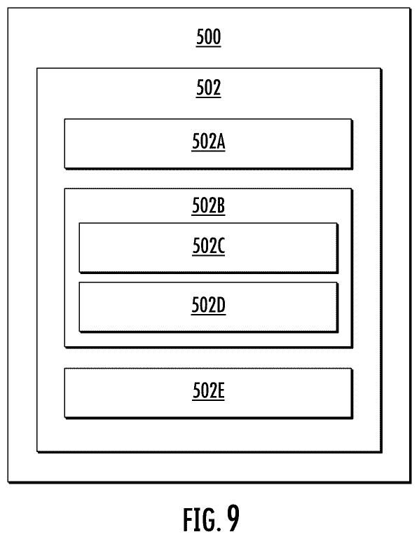

Now referring to FIG. 9, the operation of a controller 600, which may be one or more of the controllers, will be described. In at least certain embodiments, the controller 600 can include one or more computing devices 602. The computing devices 602 can include one or more processors 602A and one or more memory devices 602B. The one or more processors 602A can include any suitable processing device, such as a microprocessor, microcontroller, integrated circuit, logic device, and/or other suitable processing device. The one or more memory devices 602B can include one or more computer-readable media, including, but not limited to, non-transitory computer-readable media, RAM, ROM, hard drives, flash drives, and/or other memory devices.

The one or more memory devices 602B can store information accessible by the one or more processors 602A, including computer-readable instructions 602C that can be executed by the one or more processors 602A. The instructions 602C can be any set of instructions that when executed by the one or more processors 602A, cause the one or more processors 602A to perform operations. In some embodiments, the instructions 602C can be executed by the one or more processors 602A to cause the one or more processors 602A to perform operations, such as any of the operations and functions for which the controller 600 and/or the computing devices 602 are configured, the operations for operating power source assemblies as described herein, and/or any other operations or functions of the one or more computing devices 602. The instructions 602C can be software written in any suitable programming language or can be implemented in hardware. Additionally, and/or alternatively, the instructions 602C can be executed in logically and/or virtually separate threads on the one or more processors 602A. The one or more memory devices 602B can further store data 602D that can be accessed by the one or more processors 602A. For example, the data 602D can include data indicative of power flows, data indicative of engine/aircraft operating conditions, and/or any other data and/or information described herein.

The computing devices 602 can also include a network interface 602E used to communicate, for example, with the other components of the power source assemblies, the vehicle incorporating the power source assemblies. For example, in the embodiment depicted, as noted above, the power source assemblies include one or more sensors for sensing data indicative of one or more parameters (e.g., power level, current level, voltage). The controller 600 is operably coupled to the one or more sensors through, e.g., the network interface, such that the controller 600 may receive data indicative of various operating parameters sensed by the one or more sensors during operation. In such a manner, the controller 600 may be configured to operate the power source assemblies in response to, e.g., the data sensed by the one or more sensors.

The network interface 602E can include any suitable components for interfacing with one or more networks, including for example, transmitters, receivers, ports, controllers, antennas, and/or other suitable components.

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

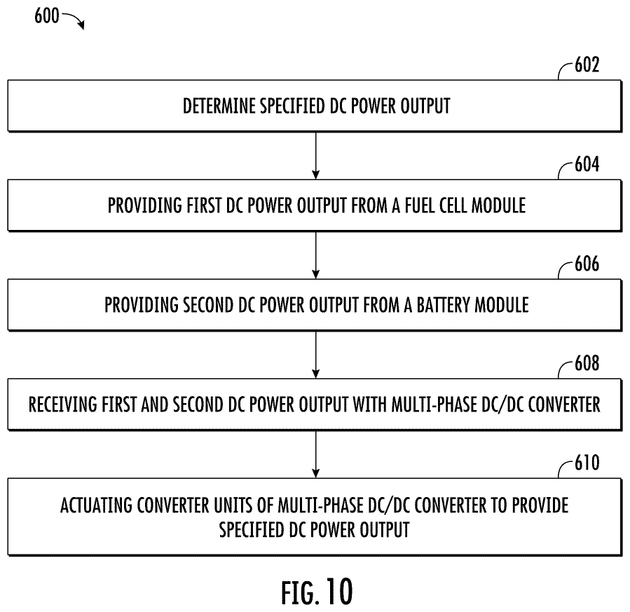

Referring now to FIG. 10, it will be appreciated that the present disclosure may further provide for a method 700 of operating a power source assembly for an aeronautical vehicle. The method 700 may be utilized with one or more of the power source assemblies described above with reference to FIGS. 1 through 9.

The method 700 includes at (702) determining a specified DC power output from the power source assembly. As described above, a controller can determine the specified DC power output as a power draw for a load that powers a component of a hybrid-electric engine for an aeronautical vehicle.

The method 700 includes at (704) providing a first DC power output from a fuel cell module. The fuel cell module ramps up power output, providing the first DC power output to supply at least a portion of the specified DC power output.

The method 700 includes at (706) providing a second DC power output from a battery module. As described above, the battery module provided the remainder of the specified DC power output while the fuel cell module ramps up.

The method 700 includes at (708) receiving the first and second DC power outputs with a multi-phase DC/DC converter. The multi-phase DC/DC converter combines the power outputs from the fuel cell module and the battery module to provide the specified DC power output.

The method 700 includes at (710) actuating one or more converter units of the multi-phase DC/DC power converter to provide the specified DC power output. As described above, the controller selectively actuates the converter units to draw more power from the fuel cell module and less power from the battery module as the fuel cell module ramps up. Additionally, when the load is zero and the fuel cell module ramps down, the controller actuates the converter units to provide the power output from the fuel cell module to the battery module.

As will be appreciated, sudden power demands of propulsion system during a flight may pose reliability and life concerns for a fuel cell system if a fuel cell system directly powers the propulsion inverter without an Auxiliary Energy Storage System (AESS), e.g., a battery, since fuel cell systems are generally suitable to operate either under constant load current or under the condition that fuel cell load current varies very slowly (on the order of several seconds). If PEMFC is subjected to sudden load current changes, the catalyst in the Membrane Electrode Assembly (MEA) may be dissolved and low reactant condition could also take place depending on the amplitude of the sudden load change, both of which shorten the life of a PEMFC. Architectures and controls of the present disclosure reduce the number of DC/DC converters used with a battery and fuel cell system without compromising the fuel cell reliability and its life by slowing down the reaction speed of the fuel cell to propulsion power changes. They also enable tight voltage regulation of the DC bus at the input of the propulsion inverter. Embodiments in FIGS. 8-9 further provide improved fault tolerance through redundancy of the electric power system components.

Further aspects are provided by the subject matter of the following clauses:

A power source assembly for an aeronautical vehicle, the power source assembly including a fuel cell module configured to provide a first direct current (DC) power output, a battery module configured to provide a second DC power output, a DC electric bus configured to provide a specified DC power output to a load, a multi-phase DC/DC converter including a plurality of converter units, the multi-phase DC/DC converter configured to receive the first DC power output from the fuel cell module and the second DC power output from the battery module and to provide the specified DC power output to the DC electric bus and a controller operably coupled to the multi-phase DC/DC converter and configured to receive data indicative of the first DC power output, the controller configured to control the plurality of converter units of the multi-phase DC/DC converter based on the data indicative of the first DC power output to maintain the specified DC power output to the load.

The power source assembly of any of the preceding clauses, wherein each of the plurality of converter units is electrically connected to at least one of the fuel cell module or the battery module, and the controller is configured to actuate each of the plurality of converter units to allow current from the fuel cell module or the battery module through each of the converter units to the DC electric bus.

The power source assembly of any of the preceding clauses, wherein each of the plurality of converter units includes a switch operable from an open state to a closed state, wherein, when the switch is in the closed state, current is provided from the fuel cell module or the battery module through the respective one of the plurality of converter units in which the switch is included to the DC electric bus.

The power source assembly of any of the preceding clauses, wherein the controller is configured to actuate the switch of each of the plurality of converter units to the open state or the closed state to provide the specified DC power output.

The power source assembly of any of the preceding clauses, wherein the switch is a first switch, wherein at least one of the plurality of converter units includes a second switch operable from an open state to a closed state, wherein the first switch electrically connects the at least one of the plurality of converter units to the fuel cell module and the second switch electrically connects the at least one of the plurality of converter units to the battery module.

The power source assembly of any of the preceding clauses, wherein the controller is configured to actuate the first switch or the second switch to the closed state to provide current from the fuel cell module or the battery module through the at least one of the plurality of converter units.

The power source assembly of any of the preceding clauses, wherein the specified DC power output is a sum of the first DC power output and the second DC power output, and wherein the controller is configured to sequentially control each of the plurality of converter units to increase a proportion of the specified DC power output from the first DC power output and to decrease a proportion of the specified DC power output from the second DC power output.

The power source assembly of any of the preceding clauses, wherein one of the plurality of converter units is electrically connected only to the fuel cell module, and another of the plurality of converter units is electrically connected only to the battery module.

The power source assembly of any of the preceding clauses, wherein an amount of DC power output that each of the plurality of converter units provides to the DC electric bus is equal.

The power source assembly of any of the preceding clauses, wherein the battery module is configured to receive the first DC power output from the fuel cell module.

The power source assembly of any of the preceding clauses, wherein the controller is configured to control the plurality of converter units as the fuel cell module increases the first DC power output.

The power source assembly of any of the preceding clauses, wherein the controller is configured to direct the first DC power output to the battery module when the specified DC power output is zero.

The power source assembly of any of the preceding clauses, wherein the second DC power output is a negative power output.

The power source assembly of any of the preceding clauses, wherein the second DC power output equals a difference between the specified DC power output and the first DC power output.

A method of operating a power source assembly for an aeronautical vehicle, the method including providing a first direct current (DC) power output from a fuel cell module, providing a second DC power output from a battery module, receiving the first DC power output and the second DC power output with a multi-phase DC/DC converter, and controlling a specified DC power output provided from the multi-phase DC/DC converter to a load by controlling each of a plurality of converter units of the multi-phase DC/DC converter as an amount of the first DC power output changes.

The method of any of the preceding clauses, further including actuating one of the plurality of converter units to provide a portion of the first DC power output to the specified DC power output.

The method of any of the preceding clauses, further including actuating one of the plurality of converter units to provide a portion of the second DC power output to the specified DC power output.

The method of any of the preceding clauses, further including actuating each of the plurality of converter units sequentially to increase an amount of the first DC power output provided to the specified DC power output.

The method of any of the preceding clauses, further including providing the first DC power output to the battery module.

The method of any of the preceding clauses, wherein the second DC power output equals a difference between the specified DC power output and the first DC power output.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A power source assembly for an aeronautical vehicle, the power source assembly comprising:
a fuel cell module configured to provide a first direct current (DC) power output;
a battery module configured to provide a second DC power output;
a DC electric bus configured to provide a specified DC power output to a load;
a multi-phase DC/DC converter including a plurality of converter units, the multi-phase DC/DC converter configured to receive the first DC power output from the fuel cell module and the second DC power output from the battery module and to provide the specified DC power output to the DC electric bus; and
a controller operably coupled to the multi-phase DC/DC converter and configured to receive data indicative of the first DC power output, the controller configured to control the plurality of converter units of the multi-phase DC/DC converter based on the data indicative of the first DC power output to maintain the specified DC power output to the load.

2. The power source assembly of claim 1, wherein each of the plurality of converter units is electrically connected to at least one of the fuel cell module or the battery module, and the controller is configured to actuate each of the plurality of converter units to allow current from the fuel cell module or the battery module through each of the converter units to the DC electric bus.

3. The power source assembly of claim 2, wherein each of the plurality of converter units includes a switch operable from an open state to a closed state, wherein, when the switch is in the closed state, current is provided from the fuel cell module or the battery module through the respective one of the plurality of converter units in which the switch is included to the DC electric bus.

4. The power source assembly of claim 3, wherein the controller is configured to actuate the switch of each of the plurality of converter units to the open state or the closed state to provide the specified DC power output.

5. The power source assembly of claim 4, wherein the switch is a first switch, and wherein at least one of the plurality of converter units includes a second switch operable from an open state to a closed state, wherein the first switch electrically connects the at least one of the plurality of converter units to the fuel cell module and the second switch electrically connects the at least one of the plurality of converter units to the battery module.

6. The power source assembly of claim 5, wherein the controller is configured to actuate the first switch or the second switch to the closed state to provide current from the fuel cell module or the battery module through the at least one of the plurality of converter units.

7. The power source assembly of claim 1, wherein the specified DC power output is a sum of the first DC power output and the second DC power output, and wherein the controller is configured to sequentially control each of the plurality of converter units to increase a proportion of the specified DC power output from the first DC power output and to decrease a proportion of the specified DC power output from the second DC power output.

8. The power source assembly of claim 1, wherein one of the plurality of converter units is electrically connected only to the fuel cell module, and another of the plurality of converter units is electrically connected only to the battery module.

9. The power source assembly of claim 1, wherein an amount of DC power output that each of the plurality of converter units provides to the DC electric bus is equal.

10. The power source assembly of claim 1, wherein the battery module is configured to receive the first DC power output from the fuel cell module.

11. The power source assembly of claim 1, wherein the controller is configured to control the plurality of converter units as the fuel cell module increases the first DC power output.

12. The power source assembly of claim 1, wherein the controller is configured to direct the first DC power output to the battery module when the specified DC power output is zero.

13. The power source assembly of claim 1, wherein the second DC power output is a negative power output.

14. The power source assembly of claim 1, wherein the second DC power output equals a difference between the specified DC power output and the first DC power output.

15. A method of operating a power source assembly for an aeronautical vehicle, the method comprising:
providing a first direct current (DC) power output from a fuel cell module;
providing a second DC power output from a battery module;
receiving the first DC power output and the second DC power output with a multi-phase DC/DC converter; and
controlling a specified DC power output provided from the multi-phase DC/DC converter to a load by controlling each of a plurality of converter units of the multi-phase DC/DC converter as an amount of the first DC power output changes.

16. The method of claim 15, further comprising actuating one of the plurality of converter units to provide a portion of the first DC power output to the specified DC power output.

17. The method of claim 15, further comprising actuating one of the plurality of converter units to provide a portion of the second DC power output to the specified DC power output.

18. The method of claim 15, further comprising actuating each of the plurality of converter units sequentially to increase an amount of the first DC power output provided to the specified DC power output.

19. The method of claim 15, further comprising providing the first DC power output to the battery module.

20. The method of claim 15, wherein the second DC power output equals a difference between the specified DC power output and the first DC power output.
